(19) United States
(12) Patent Application Publication
(10) Pub. No.: US 2009/0284101 A1
(43) Pub. Date: Nov. 19, 2009

(54) Device for Converting Mechanical Energy Into Electrical Energy, and Method for Operating Said Device

(76) Inventors: Gerald Eckstein, Munchen (DE); Ingo Kuhne, Munchen (DE)

Correspondence Address: STAAS & HALSEY LLP, SUITE 700, 1201 NEW YORK AVENUE, N.W., WASHINGTON, DC, 20005, US

(21) Appl. No.: 11/990,258

(22) PCT Filed: Jul. 27, 2006
(86) PCT No.: PCT/EP2006/064746

§ 371 Date: Feb. 11, 2008

(30) Foreign Application Priority Data
Aug. 10, 2005 (DE) 10-2005-037-876.5

(51) Int. Cl. H02N 11/00

(52) U.S. Cl. 310/300

(57) ABSTRACT

A device for converting mechanical energy into electrical energy has first electrode formed of a first material having a first work function for a charge carrier, and a second electrode formed of a second material having a second work function for a charge carrier, the second work function being different from the first work function. The first electrode and the second electrode are interconnected by a first load circuit in an electroconductive manner. The second electrode is arranged at a variable distance from the first electrode.

### CROSS REFERENCE TO RELATED APPLICATIONS

This application is based on and hereby claims priority to German Application No. 10 2005 037 876.5 filed on Aug. 10, 2005 and PCT Application No. PCT/EP2006/064746 filed on Jul. 27, 2006, the contents of which are hereby incorporated by reference.

### BACKGROUND OF THE INVENTION

There is an increasing demand in the field of sensors, actuators or data communications for autonomous microsystems which are independent of an external power supply and which guarantee wireless and maintenance-free operation. Usual autonomous Microsystems are typically based on the use of solar energy and feature solar cells for converting the solar energy into electrical energy. Because these systems are dependent on the sun or on other suitable light sources however their area of application is greatly restricted. In addition difficulties arise with these types of system with increasing miniaturization and for integration into known CMOS technology. One device known to the applicant for converting mechanical energy into electrical energy is based on electrostatic induction and employs an electret to obtain energy. An electret film is arranged at a first electrode which is provided with an electrical charge, with the first electrode being connected to a ground potential. A second electrode is arranged at a distance from the first electrode and connected via a load circuit to ground potential. The electret film is arranged between first and second electrodes. A movement of the second electrode in a direction parallel to the main surface of the first electrode causes the overlapped surface of first and second electrode and thereby the charge induced in the first electrode to change. This leads to a flow of current from the second electrode to the ground potential. The disadvantage with this arrangement is that the first electrode or the electret film respectively must first of all be provided with an electrical charge.

### SUMMARY

One potential object is thus to create an improved arrangement for converting mechanical energy into electrical energy and a method for operation of said arrangement.

The inventors propose a device for converting mechanical energy into electrical energy. The device comprises a first electrode made from a first material, which has a first work function for charge carriers and a second electrode made from a second material, which has a second work function for charge carriers, with the second work function differing from the first work function. The first electrode and the second electrode are connected electrically-conductively to each other via a first load circuit. The fact that the second electrode is arranged relative to the first electrode with a variable spacing enables an oscillating current to be impressed in a simple manner in the load circuit by imparting an oscillation to the device. The first electrode can comprise a material which is selected from a group consisting of platinum, titanium and palladium.

In one embodiment the first electrode is arranged in a recess of a surface of a first area of a first substrate part. The device can furthermore comprise a second substrate part which features a first and a second surface, with the first and the second surface of the second substrate part facing away from each other and the first surface of the second substrate part being arranged on the surface of the first substrate part. The second substrate part features a first area and a second area, with the second area of the second substrate part being coupled to a second area of the first substrate part, the first surface of the first area of the second substrate part faces towards the first electrode and the second electrode is formed by the first area of the second substrate part. A cavity is embodied between the first area of the second substrate part and the second area of the second substrate part. The cavity embodied between the first area of the second substrate part and the second area of the second substrate means that the first area of the second substrate part is not rigidly coupled to the second area of the second substrate part, while the second area of the second substrate part is coupled rigidly to the second area of the first substrate part. Advantageously the coupling strength of the second area of the second substrate part can be tailored to the first area of the second substrate part by suitable selection of the dimensioning of the cavity to a frequency of an imparted oscillation to the device such that a current impressed into the load circuit is maximized.

In an embodiment of the present invention the device furthermore features a third substrate part which features a first and a second surface, with the first and the second surface of the third substrate part facing away from each other. The first surface of the third substrate part is arranged on the second surface of the second substrate part. A third electrode made from a material with a third work function, with the third work function differing from the second work function, is embodied in a recess of a first area of the first surface of the third substrate part. The second area of the second substrate part is coupled to a second area of the third substrate part. The second surface of the first area of the second substrate part faces towards the third electrode and is spaced away from the third electrode. The second electrode and the third electrode are connected to each other via a second load circuit electrically-conductively. The advantage of the proposed device is that when an oscillation is imparted to the device an oscillating current is impressed into the first load circuit and into the second load circuit respectively.

The first substrate part comprises a second material, with the second material able to be selected from a group consisting of silicon and silicon oxide. The second substrate part comprises a third material, with the third material able to be selected from a group consisting of silicon and silicon oxide. The third substrate part comprises a fourth material, with the fourth material able to be selected from a group consisting of silicon and silicon oxide. The selection of the materials for first, second and third substrate part advantageously allows the integration of the device into components based on silicon technology.

The third electrode comprises a fifth material. The fifth material can be selected from a group consisting of platinum, titanium and palladium.

The inventors also propose a device having a second substrate part, which features a first and a second surface, with the first and the second surface of the second substrate part facing away from each other and the first surface of the second substrate part being arranged on the surface of the first substrate part. The second substrate part features a first and a second area. The second electrode is embodied on the first surface of the first area of the second substrate part. The second area of the second substrate part is coupled to a second area of the first substrate part. The second electrode faces towards the first electrode. A cavity is embodied between the first area of the second substrate part and a second area of the second substrate part. The advantage of the device is that the choice of material of the second electrode can be made independently of the choice of material of the second substrate part. This allows the difference of the work functions between first and second electrode to be increased.

In one embodiment the device furthermore comprises a third substrate part which features a first and a second surface, with the first and the second surface of the third substrate part facing away from each other. The first surface of the third substrate part is arranged on the second surface of the second substrate part. Embodied on the second surface of the first area of the second substrate part is a third electrode made from a material with a third work function. A fourth electrode made from a material with a fourth work function is embodied in a recess of the first surface of a first area of the third substrate part. The fourth work function is different from the third work function. The second area of the second substrate part is coupled to a second area of the third substrate part. The fourth electrode faces towards the third electrode and is spaced from the third electrode. The third electrode and the fourth electrode are connected electrically-conductively to each other via a second load circuit.

The first substrate part is preferably embodied from a second material, with the second material being selected from a group consisting of silicon and silicon oxide. The second substrate part preferably comprises a third material, with the third material able to be selected from a group consisting of silicon and silicon oxide. The third substrate part preferably comprises a fourth material, with the fourth material able to be selected from a group consisting of silicon and silicon oxide. The second electrode is preferably embodied from a fifth material, with the fifth material being selected from a group consisting of platinum, titanium and palladium. The third electrode preferably comprises a sixth material, with the sixth material being selected from a group consisting of platinum, titanium and palladium. The fourth electrode preferably comprises a seventh material, with the seventh material being selected from a group consisting of platinum, titanium and palladium.

The inventors further propose a device with the first electrode being arranged on a first area of a substrate and a first isolating layer being arranged between the first electrode and the substrate. The second electrode is arranged on a second area of the substrate and spaced from the substrate. The second electrode is coupled to the substrate via a flexible mechanical connection. The first electrode is rigidly connected to the substrate. The fact that the second electrode is connected via a flexible mechanical connection to the substrate enables an oscillating current to be impressed in a simple manner in the load circuit by imparting an oscillation to the device.

In one embodiment the device furthermore comprises a third electrode arranged on a third area of the substrate, which is embodied from a material with a third work function, with the third work function differing from the second work function and with a second isolating layer being arranged between the third electrode and the substrate. The second electrode and the third electrode are connected electrically-conductively to each other via a second load circuit. Preferably the first electrode and the third electrode are embodied from silicon. The second electrode preferably comprises a material which is selected from a group consisting of platinum, titanium and palladium.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 shows the structure of a device for converting electrical energy into mechanical energy according to one embodiment of the proposed device.

FIG. 2 shows a cross-section of a device for converting electrical energy into mechanical energy according to one embodiment of the proposed device.

FIG. 3 shows a cross-section of a device for converting electrical energy into mechanical energy according to one embodiment of the proposed device.

FIG. 4 shows an overhead view of a device for converting electrical energy into mechanical energy according to one embodiment of the proposed device.

FIG. 5 shows a cross-section in direction AB of the arrangement shown in FIG. 4 for converting mechanical energy into electrical energy.

FIG. 6 shows a cross-section in direction CD of the arrangement shown in FIG. 4 for converting mechanical energy into electrical energy.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

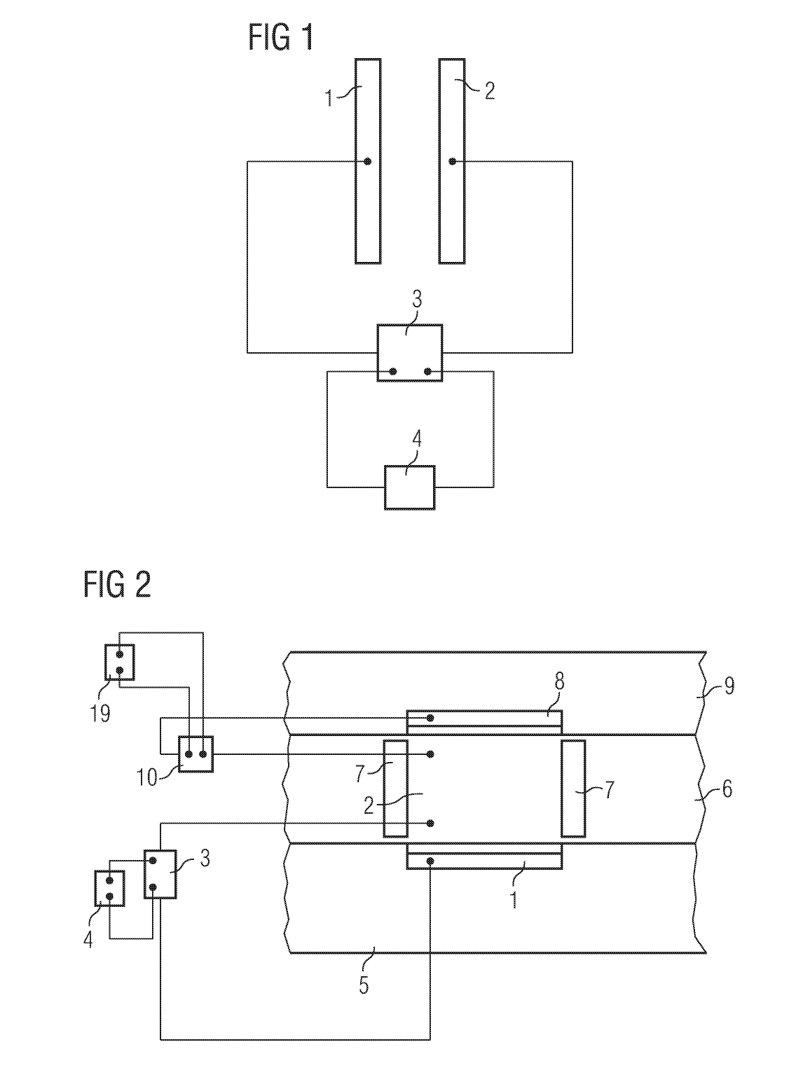

FIG. 1 shows the structure of a device for converting electrical energy into mechanical energy according to one embodiment of the proposed device. A first electrode 1 embodied from a material with a first work function and second electrode 2 embodied from a material with a second work function which is different from the first work function, are arranged so that a surface of the first electrode 1 lies opposite a surface of the second electrode 2. The different work functions of first electrode 1 and second electrode 2 mean that a capacitor formed from a first electrode 1 and a second electrode 2 has an integrated biasing voltage. On creation of an electrically-conductive connection between first electrode 1 and second electrode 2, a current flows between first electrode 1 and second electrode 2 corresponding to the potential difference of first electrode 1 and second electrode 2. The first electrode 1 and the second electrode 2 connected electrically-conductively to each other via a first load circuit 3 and the second electrode 2 is arranged in relation to the first electrode 1 with a variable spacing. A change in the distance between the second electrode 2 and the first electrode 1 effects a change in the capacitance of the capacitor formed from first electrode 1 and second electrode 2 and leads to a current flow between first electrode 1 and second electrode which can be converted by the first load circuit 3 into electrical energy. Preferably the materials of the first electrode 1 and of the second electrode 2 are selected such that the difference between the first work function of the first electrode 1 and the second work function of the second electrode 2 is as great as possible. For example the first electrode 1 can feature silicon and the second electrode 2 platinum, titanium or palladium. However other materials can also be used to form the first electrode 1 and the second electrode 2. The first electrode 1 can be rigidly connected to an external system whereas the second electrode 2 is arranged to be flexible in relation to the external system.

If a mechanical oscillation is now imparted to the external system with an oscillation frequency, the first electrode executes a mechanical movement with the oscillation frequency. Because of the flexible coupling of the second electrode 2 to the external system the second electrode 2, after a certain settling time, also executes a mechanical movement with the oscillation frequency. Depending on the strength of the flexible coupling the phase of the oscillation of the second electrode 2 is however displaced by a phase angle in relation to the oscillation of the first electrode 1. A result of the phase shift between the oscillation of the first electrode 1 and the oscillation of the second electrode 2 a change over time of the distance between first electrode 1 and second electrode 2 and thereby a change over time of the capacitance of the capacitor formed from first electrode 1 and second electrode 2 occurs.

Preferably the mass of the second electrode 2 and the coupling strength of the second electrode 2 to the external system are selected such that the inherent frequency of the system formed from second electrode 2 and the flexible coupling corresponds to the oscillation frequency imparted. This means that the change in distance between first 1 and second electrode 2 occurs periodically and the amount of current induced by the changes over time of the distance between first electrode 1 and second electrode 2 averaged over time is maximized. The external system can for example be a motor which vibrates and thus creates the mechanical movement with the oscillation frequency. The current occurring at the first load circuit 3 can also be fed to an accumulator or another form of storage for electrical energy. The voltage present at the load circuit 3 can be tapped off via a device for tapping off a voltage 4.

The arrangement is especially advantageous since the capacitor, through the different work functions of first electrode 1 and second electrode 2, features an integrated biasing voltage, with the application of charges to one of the two electrodes being omitted before the device for converting mechanical energy into electrical energy is put into service.

FIG. 2 shows a cross-section of an arrangement for converting mechanical energy into electrical energy according to one embodiment of the proposed device. A first electrode 1, which is embodied from a material which has a first work function, is arranged in a recess of a first surface in a first area of a first substrate part. The first electrode 1 can contain platinum, titanium, palladium or another material. The first substrate part 5 preferably contains silicon or silicon oxide. Arranged on the first surface of the first substrate part 5 is a first surface of a second substrate part 6, with a second area of the second substrate part 6 being connected to a second area of the first substrate part 5. The second substrate part 6 also features a second surface which faces away from the first surface of the second substrate part 6. Preferably the second area of the first substrate part 5 is rigidly coupled to the second area of the second substrate part 6. The rigid coupling can be undertaken by a wafer bonding method. The second substrate part 6 preferably contains silicon or silicon oxide.

The second substrate part 6 features a cavity 7 between a first area of the second substrate part 6 and the second area of the second substrate part 6. The cavity 7 can for example be embodied by etching. The dimensions of the cavity 7, especially in the direction perpendicular to the first surface of the second substrate part 6 define the coupling strength between the first area of the second substrate part 6 and the second area of the second substrate part 6. But the dimension of the cavity 7 in the direction parallel to the first surface of the second substrate part 6 also has an influence on the coupling strength between the first area of the second substrate part 6 and the second area of the second substrate part If the dimension of the cavity 7 perpendicular to the first surface of the second substrate part 6 for example amounts to almost the thickness of the second substrate part 6, then the coupling strength between the first and the second area of the second substrate part 6 is small. The dimensions of the cavity 7 can be different in different areas between the first area and the second area of the second substrate part 6. For example first and second area of the second substrate part 6 can be not connected to one another in some areas of the second substrate part 6, or the first and second area of the second substrate part 6 can only be connected to each other in the vicinity of the first of the second surface of the second substrate part 6 respectively. As an alternative the first and second area of the second substrate part 6 can also only be connected through a material of the second substrate part 6 arranged between first and second surface of the second substrate part 6.

The first area of the second substrate part 6 represents a second electrode 2 of a capacitor which is formed by the first 1 and the second electrode 2. The first electrode 1 and the second electrode 2 are arranged in a perpendicular direction to the first surface of the second substrate part 6 spaced from each other, and the second electrode is formed from a material having a second work function which differs from the first work function. The first electrode and the second electrode are connected electrically-conductively to each other via a first load circuit.

Arranged on the second surface of the second substrate part 6 is a first surface of a third substrate part 9. Embodied in a first area of the first surface of the third substrate part 9 is a third electrode 8 made from a material which has a third work function which is different from the second work function. The second electrode 2 and the third electrode 8 form two electrodes of a second capacitor. The third electrode can for example contain platinum, titanium, palladium or another material. The third electrode 8 is arranged at a distance from the second electrode 2 in a direction perpendicular to the first surface of the third substrate part 9. A second area of the third substrate part 9 is coupled to the second area of the second substrate part 6, with the second area of the second substrate part 6 preferably being rigidly coupled to the second area of the third substrate part 9. The rigid coupling can be undertaken by a wafer bonding method for example. The second electrode and the third electrode are connected electrically-conductively to each other via a second load circuit 10.

If a mechanical oscillation is imparted to the overall system formed from the first 5, second 6 and third substrate part 9 with an oscillating frequency which has a component perpendicular to the first surface of the second substrate part 6, then the second electrode 2 after a certain settling phase as a consequence of the flexible coupling of the first area of the second substrate part 6 to the second area of the second substrate part 6 and as a consequence of the inertia of the mass of the second electrode 2, likewise executes a periodic movement with the oscillation frequency. Depending on the strength of the coupling between the first area and the second area of the second substrate part 6 the phase of the oscillation of the second electrode 2 is however displaced by a phase angle compared to the oscillation of the first electrode 1.

If the strength of the coupling between the first area and the second area of the second substrate part 6 and the mass of the first area of the second substrate part is selected such that the inherent frequency of the system formed from them corresponds to the oscillation frequency imparted to the overall system, the distance between second electrode 2 and first or third electrode 8 respectively changes periodically and induces a current flow between second 2 and first 1 or second 2 and third electrode respectively. The voltage present at the load circuit 3 can be tapped off via a first device for tapping off a voltage 4. The voltage present at the load circuit 10 can be tapped off via a second device for tapping off a voltage 19.

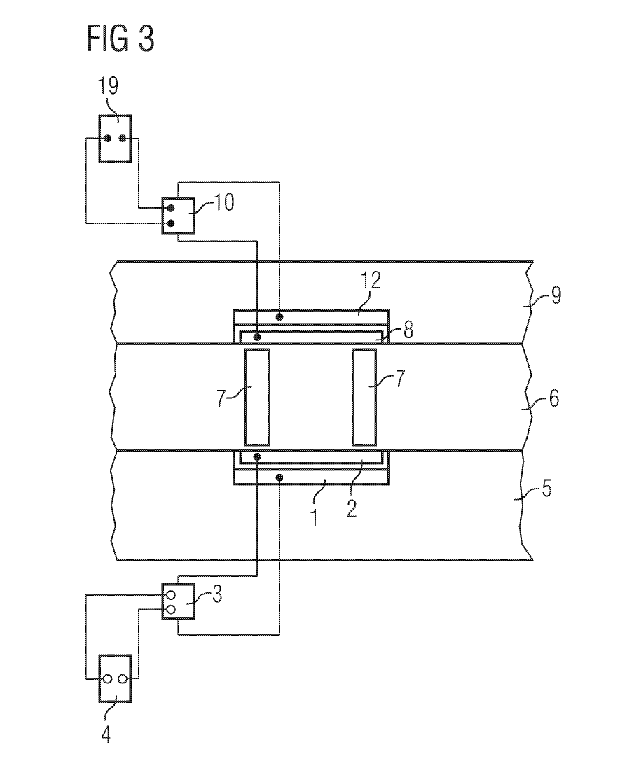

FIG. 3 shows a cross-section of an arrangement for converting mechanical energy into electrical energy according to one embodiment of the proposed device. A first electrode 1, which is embodied from a material which has a first work function, is arranged in a recess of a first surface in a first area of a first substrate part. Arranged on the first surface of the first substrate part 5 is a first surface of a second substrate part 6, with a second area of the second substrate part 6 being connected to a second area of the first substrate part 5. The second substrate part 6 also features a second surface which faces away from the first surface of the second substrate part 6. Preferably the second area of the first substrate part 5 is rigidly coupled to the second area of the second substrate part 6. The rigid coupling can be undertaken by a wafer bonding method.

The second substrate part 6 features a cavity 7 between a first and the second area of the second substrate part 6. The cavity 7 can for example be embodied by etching.

A second electrode 2 is embodied in the first area of the first surface of the second substrate part 6. The first electrode 1 and the second electrode 2 represent the two electrodes of a first capacitor of the device.

The first electrode 1 and the second electrode 2 are arranged in a perpendicular direction to the first surface of the second substrate part 6 at a distance from each other, and the second electrode 2 is formed from a material having a second work function which differs from the first work function. The first electrode 1 and the second electrode 2 are connected electrically-conductively to each other via a first load circuit 3.

Embodied on the second surface of the second substrate part 6 in the first area is a third electrode 8 made from a material with a third work function.

A first surface of a third substrate part 9 is arranged on the second surface of the second substrate part 6.

In a recess of a first area of the first surface of the third substrate part 9 is a fourth electrode 12 embodied from a material, which has a fourth work function which differs from the third work function. The third electrode 8 and the fourth electrode 12 form two electrodes of a second capacitor of the device. The fourth electrode 12 is arranged at a distance from the third electrode 8 in a direction perpendicular to the first surface of the third substrate part 9. A second area of the third substrate part 9 is coupled to the second area of the second substrate part 6, with the second area of the second substrate part 6 preferably being rigidly coupled to the second area of the third substrate part 9. The rigid coupling can be undertaken by a wafer bonding method for example. The third electrode 8 and the fourth electrode are connected electrically-conductively to each other via a second load circuit 10.

First electrode 1, second electrode 2, third electrode 8 and fourth electrode 12 are preferably embodied from platinum, titanium or palladium.

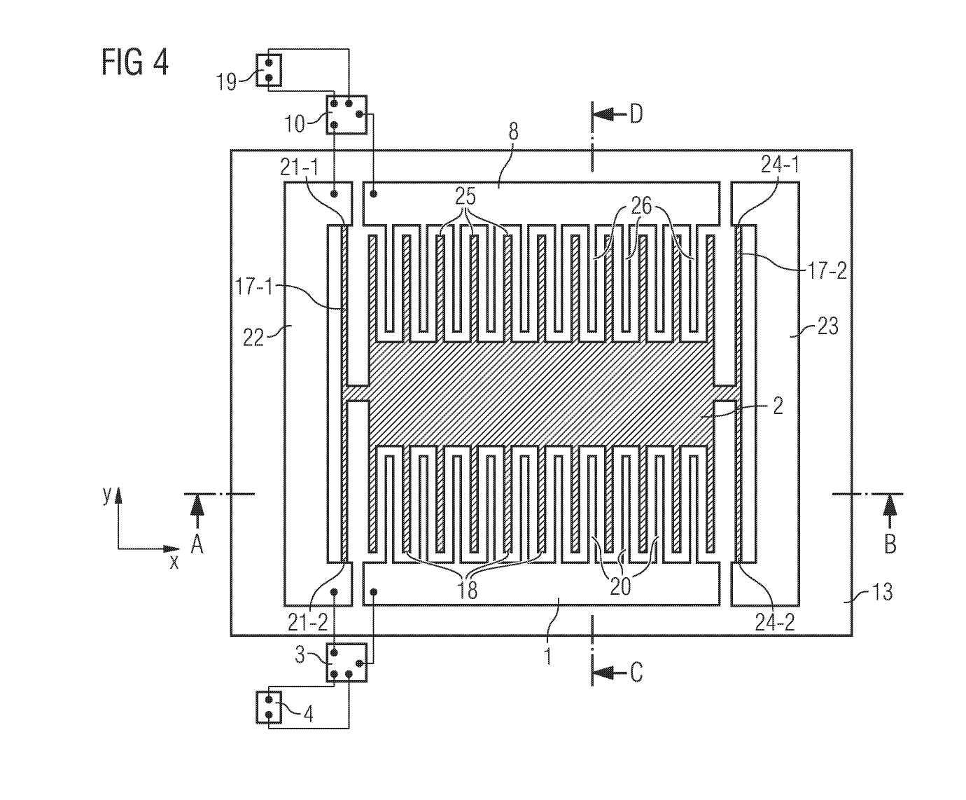

FIG. 4 shows an overhead view of an arrangement for converting mechanical energy into electrical energy according to an embodiment of the proposed device. A first electrode 1 which is formed from a material with a first work function, is embodied on a first area of a substrate 13, with a first isolating layer 14 (not shown in FIG. 4) being arranged between a partial area of the first electrode 1 and the substrate 13. The first electrode is rigidly connected to the substrate.

A second electrode 2 is embodied on a second area of the substrate 13, with the second electrode 2 being arranged at a distance from the substrate 13 and a cavity (not shown in FIG. 4) being embodied between the second electrode 2 and the substrate 13. The second electrode 2 is embodied from material which has a second work function which differs from the first work function of the first electrode 1.

A third electrode 8 is embodied on a third area of the substrate 13, with a second isolating layer 15 (not shown in FIG. 4) being arranged between a partial area of the third electrode 8 and the substrate 13. The third electrode 8 is embodied from material which has a third work function which differs from the second work function of the second electrode 8. The third electrode is rigidly connected to the substrate 13.

The first electrode 1 is embodied as a comb-like structure. Extending from the partial area of the first electrode 1 are teeth 20 in a first direction (y). Between the teeth 20 of the first electrode 1 and the substrate 13 is embodied a cavity (not shown in FIG. 4).

The second electrode 2 has a double comb-shaped structure, with first teeth 18 extending from a partial area of the second electrode 2 along a second direction opposite to the first direction (y) and second teeth 25 extending from the partial area of the second electrode 2 in a first direction (y).

The teeth 20 of the first electrode 1 and the first teeth 18 of the second electrode 2 are arranged to intermesh and are spaced from each other.

The second electrode 2 is coupled via at least one flexible electrically-conductively connecting element 17 to the substrate 13. A first 17-1 and a second electrically-conductive flexible connecting element 17-2 are arranged in the vicinity of sides of the second electrode 2 facing away from each other. The first 17-1 and the second electrically-conductive flexible connecting element 17-2 are arranged spaced from the substrate and extend in the first direction (y).

Opposite ends 21-1, 21-2 of the first electrically-conductive, flexible connection element 17-1 are coupled to the substrate 13 by a first conductive structured layer 22 in a fourth area of the substrate 13 and spaced from the substrate 13 by a third isolating layer 16 (not shown in FIG. 4).

Opposite ends 24-1, 24-2 of the second electrically-conductive, flexible connection element 17-2 are coupled to the substrate 13 by a second conductive structured layer 23 in a fifth area of the substrate 13 and spaced from the substrate 13 by a fourth isolating layer 11 (not shown in FIG. 4).

The third electrode 8 is embodied as a comb-like structure, with teeth 26 of the third electrode 8 extending from the partial area of the third electrode 8 in the second direction. Between the teeth 26 of the third electrode 8 and the substrate 13 is embodied a cavity (not shown in FIG. 4). The teeth 26 of the third electrode 8 and the first teeth 25 of the second electrode 2 are arranged to intermesh with each other.

The first electrode 1 and the second electrode 2 are connected electrically-conductively to each other via a first load circuit 3. The second electrode 2 and the third electrode 8 are connected to each other electrically-conductively via a second load circuit 10. The first electrode 1 and the third electrode 8 are preferably embodied from silicon. The second electrode 2 preferably contains, platinum, titanium, palladium or another suitable electrode material.

If a mechanical oscillation is supplied to the system formed from substrate 13, first electrode 1, second electrode 2 and third electrode 8 with an oscillating frequency which features a component perpendicular to the first direction (y) and parallel to a surface of the substrate 13, the second electrode 2 after a certain settling time as a consequence of the flexible coupling 17 to the substrate 13 and as a consequence of the inertia of the mass of the second electrode 2, likewise carries out a periodic movement with the supplied oscillation frequency. Depending on the strength of the coupling between the second electrode 2 and the substrate 13 the phase of the oscillation of the second electrode 2 is shifted however by a phase angle in relation to the oscillation of the first electrode 1 and of the third electrode 8.

If the strength of the coupling between the second electrode 2 and the substrate 13 and the mass of the first area of the second substrate part is selected such that the inherent frequency of the system formed therefrom corresponds to the oscillating frequency supplied to the system, the distance between second electrode 2 and first 1, or third electrode 8 respectively changes periodically and induces a current flow between second 2 and first 1 or second 2 and third electrode 8 respectively. The voltage present at the first load circuit can be tapped off using a first device for tapping a voltage 4. The voltage present at the second load circuit 10 can be tapped off via a second device for tapping off a voltage 19.

FIG. 5 shows a cross-section in direction AB of the arrangement shown in FIG. 4 for converting mechanical energy into electrical energy. The teeth 20 of the first electrode 1 and the first teeth 18 of the second electrode 2 are arranged alternately along a third direction (x) and spaced from the substrate 13. A cavity is embodied between the teeth 20 of the first electrode 1 and the first teeth 18 of the second electrode 2. The first 17-1 and the second electrically-conductive flexible connecting element 17-2 are arranged on the substrate 13 in the vicinity of sides of the second electrode 2 facing away from each other, with a cavity being embodied between the electrically-conductive flexible connection elements 17-1, 17-2 and the substrate 13. The first structured conductive layer 22 is arranged on a side of the first electrically-conductive flexible connection element 17-1 facing away from the second electrode 2. A third isolating layer 16 is embodied between the first structured conductive layer 22 and the substrate 13. The second structured conductive layer 23 is arranged on a side of the second electrically-conductive flexible connection element 17-2 facing away from the second electrode 2. A fourth isolating layer 11 is embodied between the second structured conductive layer 23 and the substrate 13.

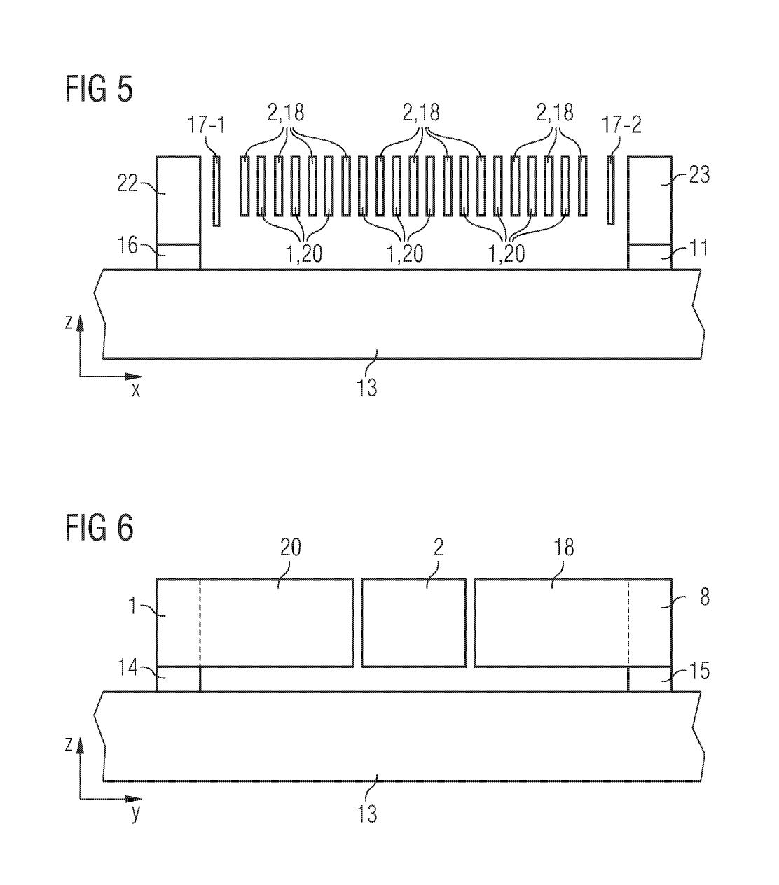

FIG. 6 shows a cross-section in direction CD of the arrangement shown in FIG. 4 for converting mechanical energy into electrical energy. A first electrode 1 is embodied on a first area of the substrate 13, with a first isolating layer 14 being arranged between a partial area of the first electrode 1 and the substrate 13. Starting from the partial area of the first electrode 1, teeth 20 of the first electrode 1 extend in the first direction (y), with the teeth 20 being spaced from the substrate 13. A second electrode 2 is arranged on a second area of the substrate 13, with the second electrode 2 being arranged spaced away from the substrate 13 and a cavity being embodied between the second electrode 2 and the substrate 13. A third electrode 8 is embodied on a third area of the substrate 13, with a second isolating layer 15 being arranged between a partial area of the third electrode 8 and the substrate 13. Starting from the partial area of the second electrode 2, teeth 18 of the second electrode 2 extend in a direction opposite to the first direction (y), with the teeth 18 being spaced from the substrate 13.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-22. (canceled)

23. A device for converting mechanical energy into electrical energy, comprising: a first electrode made from a first material which has a first work function for charge carriers;
a second electrode made from a second material which has a second work function for charge carriers, with the second work function differing from the first work function, the second electrode being arranged with a variable spacing relative to the first electrode; and
a load circuit, the first electrode and the second electrode being connected electrically-conductively to each other via the first load circuit.

24. The device as claimed in claim 23, wherein the first material of the first electrode is selected from the group consisting of platinum, titanium and palladium.

25. The device as claimed in claim 23, further comprising a first substrate having a surface with a recess, the first electrode being positioned within the recess of the first substrate.

26. The device as claimed in claim 25, wherein
the device further comprises a second substrate having first and second surfaces that oppose one another,
the first surface of the second substrate faces the first electrode and contacts the surface of the first substrate,
the first substrate has first and second sections,
the second substrate has first and second sections,
the second section of the first substrate is coupled to the second section of the second substrate,
the second electrode is formed as part of the second substrate, and
a cavity is formed in the second substrate at a vicinity of an intersection between the first and second sections of the second substrate.

27. The device as claimed in claim 26, wherein
the device further comprises a third substrate having first and second opposing surfaces,
the first surface of the third substrate contacts and is attached to the second surface of the second substrate,
a third electrode made from a material with a third work function, which differs from the second work function, is formed in a recess in the first surface of the third substrate,
the third substrate has first and second sections,
the third electrode is positioned in the first section of the third substrate,
the second surface of the second substrate faces the third electrode and is spaced from third electrode,
the second section of the second substrate is coupled to the second section of the third substrate, and
the second electrode and the third electrode are connected electrically-conductively via a second load circuit.

28. The device as claimed in claim 27, wherein
the first substrate is formed from a material selected from the group consisting of silicon and silicon oxide;
the second substrate is formed from a material selected from the group consisting of silicon and silicon oxide;
the third substrate is formed from a material selected from the group consisting of silicon and silicon oxide;
the material forming the third electrode is selected from the group consisting of platinum, titanium, and palladium.

29. The device as claimed in claim 25, wherein
the device further comprises a second substrate having first and second surfaces that oppose one another,
the first surface of the second substrate contacts and is attached to the surface of the first substrate
the second electrode contacts the first surface of the second substrate,
the first substrate has first and second sections,
the second substrate has first and second sections,
the second section of the first substrate is coupled to the second section of the second substrate,
the second electrode faces towards the first electrode, and
a cavity is formed in the second substrate at a vicinity of an intersection between the first and second sections of the second substrate.

30. The device as claimed in claim 29, wherein
the device further comprises a third substrate having first and second surfaces that oppose one another,
the first surface of the third substrate contacts and is attached to the second surface of the second substrate,
a third electrode made from a material with a third work function contacts the second surface of the second substrate,
the third substrate has first and second sections,
the third electrode is positioned between the first section of the second substrate and the first section of the third substrate,
a fourth electrode made from a material with a fourth work function, which differs from the second work function is formed in a recess in the first surface of the third substrate,
the recess is formed at the first section of the third substrate,
the fourth work function differs from the third work function,
the second section of the second substrate is coupled to a second section of the third substrate,
the fourth electrode faces towards the third electrode and is spaced from the third electrode, and
the third and fourth electrodes are connected electrically-conductively to each other via a second load circuit.

31. The device as claimed in claim 30, wherein
the first substrate is formed from a material selected from the group consisting of silicon and silicon oxide,
the second substrate material is formed from a selected from the group consisting of silicon and silicon oxide,
the third substrate is formed from a selected from the group consisting of silicon and silicon oxide,
the second material forming the second electrode is selected from the group consisting of platinum, titanium, and palladium,
the material forming the third electrode is selected from the group consisting of platinum, titanium, and palladium, and
the fourth electrode is formed from a material selected from a group consisting of platinum, titanium, and palladium.

32. The device as claimed in claim 23, wherein
the first electrode is arranged on a first area of a substrate and a first isolating layer is arranged between the first electrode and the substrate,
the second electrode is arranged on a second area of the substrate and is spaced from the substrate, and
the second electrode is coupled via a flexible mechanical connection to the substrate.

33. The device as claimed in claim 32, wherein
the device further comprises a third electrode arranged on a third area of the substrate, the third electrode being made from a material with a third work function,
the third work function is different from the second work function,
a second isolating layer is arranged between the third electrode and the substrate, and
the second electrode and the third electrode are connected electrically-conductively via a second load circuit.

34. The device as claimed in claim 33, wherein the first and third electrodes are formed from silicon.

35. The device as claimed in claim 34, with the second material forming the second electrode is selected from the group consisting of platinum, titanium and palladium.

36. A method for operating a device for converting mechanical energy into electrical energy, comprising:
providing a device for converting mechanical energy into electrical energy as claimed in claim 25;
imparting a mechanical oscillation to the device; and
tapping a voltage at the first load circuit.

37. A method for operating a device for converting mechanical energy into electrical energy comprising:
providing a device for converting mechanical energy into electrical energy as claimed in claim 25;
imparting a mechanical oscillation to the device; and
tapping a voltage at the first load circuit.

38. A method for operating a device for converting mechanical energy into electrical energy comprising:
providing a device for converting mechanical energy into electrical energy comprising:
a first electrode made from a first material which has a first work function for charge carriers;
a second electrode made from a second material which has a second work function for charge carriers, with the second work function differing from the first work function, the second electrode being arranged with a variable spacing relative to the first electrode;
a load circuit, the first electrode and the second electrode being connected electrically-conductively to each other via the first load circuit;
a first substrate having a surface with a recess, the first electrode being positioned within the recess of the first substrate;
a second substrate having first and second surfaces that oppose one another, wherein
the first surface of the second substrate faces the first electrode and contacts the surface of the first substrate,
the second electrode is formed as part of the second substrate, and
a cavity is formed between the first and second surfaces of the second substrate;
imparting a mechanical oscillation to the device; and
tapping a voltage at the first load circuit.

39. A method for operating a device for converting mechanical energy into electrical energy comprising:
providing a device for converting mechanical energy into electrical energy as claimed in claim 28;
imparting a mechanical oscillation to the device;
tapping a voltage at the first load circuit; and
tapping a voltage at the second load circuit.

40. A method for operating a device for converting mechanical energy into electrical energy comprising:
providing a device for converting mechanical energy into electrical energy comprising:
a first electrode made from a first material which has a first work function for charge carriers;
a second electrode made from a second material which has a second work function for charge carriers, with the second work function differing from the first work function, the second electrode being arranged with a variable spacing relative to the first electrode;
a load circuit, the first electrode and the second electrode being connected electrically-conductively to each other via the first load circuit;
a first substrate having a surface with a recess, the first electrode being positioned within the recess of the first substrate;
a second substrate having first and second surfaces that oppose one another, wherein
the first surface of the second substrate contacts and is attached to the surface of the first substrate the second electrode contacts the first surface of the second substrate,
the second electrode faces towards the first electrode, and
a cavity is formed between the first and second surfaces of the second substrate;
imparting a mechanical oscillation to the device; and
tapping a voltage at the first load circuit.

41. A method for operating a device for converting mechanical energy into electrical energy comprising:
providing a device for converting mechanical energy into electrical energy as claimed in claim 30;
imparting a mechanical oscillation to the device;
tapping a voltage at the first load circuit; and
tapping a voltage at the second load circuit.

42. A method for operating a device for converting mechanical energy into electrical energy comprising:
providing a device for converting mechanical energy into electrical energy as claimed in claim 31;
imparting a mechanical oscillation to the device;
tapping a voltage at the first load circuit; and
tapping a voltage at the second load circuit.

43. A method for operating a device for converting mechanical energy into electrical energy comprising:
providing a device for converting mechanical energy into electrical energy as claimed in claim 32;
imparting a mechanical oscillation to the device; and
tapping a voltage at the first load circuit.

44. The method for operating a device for converting mechanical energy into electrical energy comprising:
providing a device for converting mechanical energy into electrical energy as claimed in claim 33;
imparting a mechanical oscillation to the device;
tapping a voltage at the first load circuit; and
tapping a voltage at the second load circuit.
